(19) United States
(12) Patent Application Publication
(10) Pub. No.: US 2026/0185680 A1
(43) Pub. Date: Jul. 2, 2026

(54) LENS CONFIGURATION FOR LIGHT FIXTURES

(71) Applicant: FOHSE INC., Las Vegas, NV (US)

(72) Inventor: Alex Gerard, Rogers, MN (US)

(21) Appl. No.: 19/225,292

(22) Filed: Jun. 2, 2025

Related U.S. Application Data
(60) Provisional application No. 63/655,707, filed on Jun. 4, 2024.

(51) Int. Cl. F21V 5/00; F21S 4/28; F21V 7/00; F21V 7/24; F21V 17/06; F21W 131/109; F21Y 105/16; F21Y 115/10

(52) U.S. Cl. CPC F21V 5/007; F21S 4/28; F21V 7/0083; F21V 7/24; F21V 17/06; F21W 2131/109; F21Y 2105/16; F21Y 2115/10

(57) ABSTRACT

Lenses, such as for a light fixture including a printed circuit board and a number of light emitting diodes electrically connected to the printed circuit board, have a lens support in the form of a light guide, and a lens body associated with the light guide, wherein the lens support and the lens body are made of different materials. The lens support may be constructed from a polymer, while the lens body is glass. The light guide defines an internal reflective surface for reflecting/directing light from one or more LEDs to the lens body.

### RELATED APPLICATION DATA

This application claims priority to U.S. Provisional Application Ser. No. 63/655,707, filed Jun. 4, 2024, which application is incorporated by reference herein in its entirety.

### FIELD OF THE INVENTION

The present invention relates to light fixtures, and particularly to LED based light fixtures which are used for horticultural purposes.

### BACKGROUND OF THE INVENTION

A wide variety of light fixtures have been developed. In general, all light fixtures are configured to include at least one light emitting element. However, the particular light emitting element which is utilized, as well as other features of the light fixture, may vary, such as depending upon the intended primary use.

Light fixtures which are used for horticultural purposes, often known as “grow lights,” often utilize light emitting diodes (LEDs) as the light emitting elements. The LEDs may be electrically connected to one or more printed circuit boards. These light fixtures commonly include a lens structure which is located over the LEDs. Commonly the lens structure is a plastic body which defines a plurality of lens elements.

One problem with this prior art arrangement is that light, and particularly ultraviolet (UV) light, from the LEDs is known to break down the plastic lens structures. This leads to discoloration and structural degradation, which in turn decreases the effectiveness and life of the light.

It is with respect to these and other considerations that the instant disclosure is concerned.

### SUMMARY OF THE INVENTION

Aspects of the invention comprise lenses and lens structures for light fixtures, and light fixtures having one or more lenses.

One embodiment of the invention comprises a light fixture comprising a printed circuit board, a number of light emitting diodes (LEDs) electrically connected to the printed circuit board, and at least one lens associated with one or more of the LEDs, the at least one lens comprising a lens support comprising a light guide, and a lens body associated with the light guide, wherein the lens support and the lens body are made of different materials.

The light guide is designed to direct light from one or more LEDs to the associated lens body. The light guide may define an internal reflective surface that defines a light transmitting passage. In one embodiment, the lens support is constructed from plastic, while the lens body is constructed from glass.

Further objects, features, and advantages of the present invention over the prior art will become apparent from the detailed description of the drawings which follows, when considered with the attached figures.

### DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIGS. 1 and 2 are assembled isometric and exploded isometric views, respectively, of a light fixture, in accordance with one non-limiting embodiment of the disclosed concept.

FIG. 3 is an enlarged view of a portion of the light fixture of FIG. 2.

FIGS. 4 and 5 are assembled isometric and exploded isometric views, respectively, of another light fixture, in accordance with another non-limiting embodiment of the disclosed concept.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

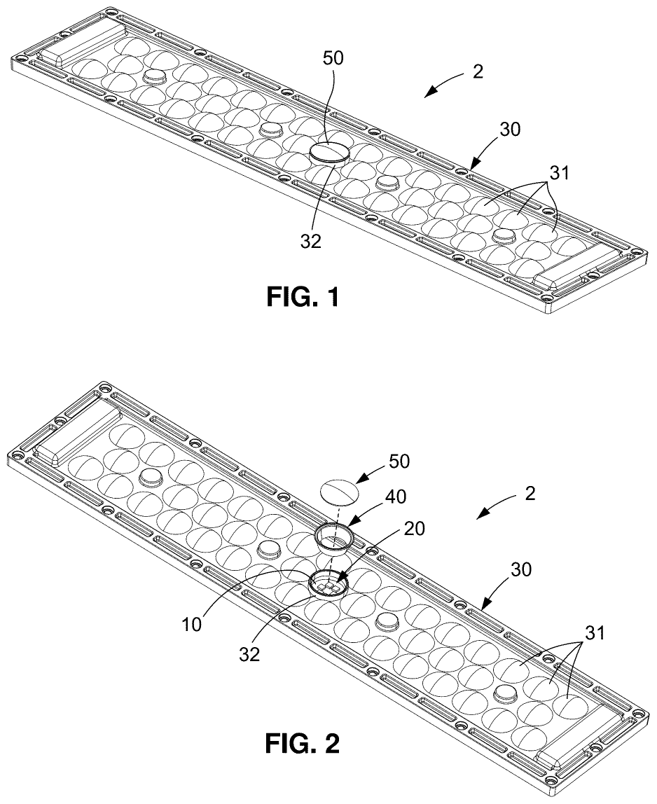

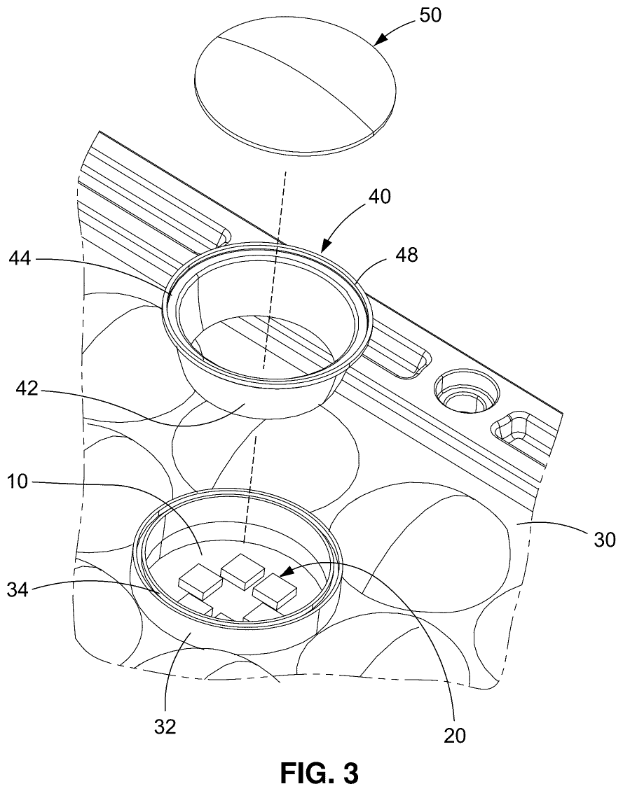

FIGS. 1 and 2 show different views of a light fixture 2, and FIG. 3 shows an enlarged view of a portion of the light fixture illustrated in FIG. 2, in accordance with one non-limiting embodiment of the disclosed concept. As shown in FIG. 3, the example light fixture 2 includes one or more illumination elements. In one embodiment, the illumination elements comprise at least one, and preferably a number of LEDs 20. The LEDs may be associated with a substrate, such as a printed circuit board 10 (partially shown in FIG. 2), such as by being electrically connected to the printed circuit board 10. In addition, a lens support 30 is associated with the LEDs 20. In one embodiment, the LEDs 20 and associated printed circuit board 10 may be mounted to or otherwise supported by a housing, frame or other support structure. Likewise, the lens support 30 may be connected to the housing, the printed circuit board 10 or the like.

As illustrated in FIG. 2, the light fixture 2 includes one or more lenses 31, where each lens 31 is configured to direct light from at least one LED (not shown in FIG. 2). In one embodiment, each lens 31 comprises a lens support 30 for supporting a lens or lens body 50. In one embodiment, the lens support 30 is made of a first material, such as plastic (or other polymers), such as a polycarbonate. In general, the lens support 30 may be configured to define or include lenses 31 at locations corresponding to LEDs 20 on the printed circuit board 10, such as relative to groups of LEDs which may contain one or more individual LEDs (such as clusters of two or more LEDs), whereby one or more LEDs are located under a particular lens 31.

In accordance with the disclosed concept, the lens support 30 includes one or more features which are designed to minimize damage thereto by the light emitted by the one or more LEDs.

More specifically, the lens support 30 defines a light guide 40. The light guide 40 preferably serves to direct light from the one or more LEDs 20 to the lens body 50. In one embodiment, the light guide 40 may comprise a wall having an interior which defines at least one passage. Preferably, the light guide 40 (or at least an inner surface of the wall thereof) is made from, or coated with, one or more metallic or other highly light reflective materials. Each lens 31 further comprises a lens body 50 coupled to the light guide 40 (or otherwise located a top thereof).

In one embodiment, the light guides 40 are configured to reflect and direct light (including damaging UV light) emanated by the LEDs 20 to the lens body 50 and to prevent (or minimize) the passage of light from the LEDs 20 through the lens support 30.

The configuration of the lens support 30, may vary. For example, referring to FIG. 2, the lens support 30 may include or define a light guide or reflector receiving portion 32, such as an upwardly extending extension or mount. In one example, the receiving portion 32 is tubular or cylinder-shaped and includes an annular-shaped rim 34 (FIG. 3).

As shown in FIG. 3, the light guide 40 may then comprise a frustoconical-shaped body portion 42 having a first or bottom end and a second or top end. An extension, such as a disc-shaped annular shelf portion 44, may extend radially outward from the body portion 42, such as at the second end thereof. The interior of the body portion 42 preferably acts as a light guide, and is thus preferably reflective, so as to reflect light from the one or more LEDs 20 towards the lens body 50 through a passage (which may be filled with air, a particular gas or gasses, liquid, be void or be filled with a light transmitting solid or other material) defined by the reflector member 40 from the bottom to the top end thereof. The first end of the body portion 42 may be configured to fit into (or over, or otherwise engage or connect to) one of the receiving portions 32 of the lens support 30, with the shelf portion 44 configured to be located on and/or supported by the rim 34. Further, the light guide 40 preferably defines a lens body 50 receiving portion or element, such as an inset 46 defined by the shelf portion 44.

A lens body 50 is preferably associated with the receiving portion of the light guide 40, such as the inset 46. The lens body 50 might be connected to the light guide 40 in various manners, such as by adhesive, a mechanical connection or the like.

In a preferred configuration, the lens body 50 is advantageously made of glass, and may be configured (such as shaped) to direct light in specific manners, such as to redirect light at one or more specific angles.

As a result of the use of a glass lens body 50, it can be appreciated that the light fixture 2 is advantageously able to have a lens 31 made of two different materials: a main body (such as the receiving portions 32 and light guides 40) made of plastic (or other polymers, including polycarbonates), or other suitable material (such as where the lens support 30 can be molded), and then lens bodies 50 which are constructed of glass. Notably, the light from the LEDs 20 which is reflected by the light guides 40 passes through the corresponding lens body 50. Because the lens body 50 is constructed from glass, degradation which would otherwise occur if the lens body 50 were constructed from plastic (or other polymers), is prevented.

Further, in this preferred configuration the construction of the lens support 30 reduces the cost thereof (as compared, for example, to a solution where the entire lens 31, including both the supporting structure and the lens body, is constructed from glass), and allows the lens support 30 to have a relative low mass (which is desirable, as these light fixtures are generally large and supported in elevated positions, where the mass of the light can make such mounting difficult and expensive).

For example, while glass lenses are typically more expensive than plastic (such as polycarbonate) ones, employing glass only with the lens or lens body 50 (e.g., or an isolated number of other lenses in a suitable alternative light structure (not shown)) allows the benefits of glass to be realized at a fraction of the cost. That is, the light fixture 2 is configured to be manufactured with only a fraction of the overall lenses being made from glass, thus reducing the overall cost.

In one embodiment, the lens support 30 (such as the receiving portion 32) is configured so that the first end thereof is located near the LEDs 20, such as adjacent to the printed circuit board 10 on which the LEDs 20 are located. This reduces light “leakage” outside of the lens support 30, thus protecting the plastic/polycarbonate lens structure from damage.

In the illustrated example, the lens support 30 and the lens bodies 50 are centrally located in the light fixture 2, both in lateral and longitudinal directions. However, it will be appreciated that other suitable arrangements are contemplated, including off center receiving portions, reflector members, and lens bodies. It will also be appreciated that light fixtures in accordance with the disclosed concept may include a plurality of receiving portions, reflector members, and lens bodies, without departing from the scope of the disclosed concept.

In one embodiment, a portion of the light guide 40 may be frusto-conical. However, the light guide 40 may have a light guide portion of other shapes (where a primary purpose is to direct light from the one or more LEDs to the associated lens body 50).

For example, while in one configuration a separate light guide 40 and lens body 50 are corresponding to each lens 31, in some embodiments, multiple light guides 40 might be connected in a group and might correspond to a group of lenses 31. Further, while in a preferred embodiment each lens 31 includes a light guide 40 and lens body 50, in some embodiments, not every single lens 31 may have that construction. For example, relative to certain LEDs or groups of LEDs 20, such as where those LEDs don't emit significant UV light, the lens or lens body 50 may comprise a portion of the lens support 30 (and thus, in the preferred configuration, be plastic/polycarbonate), while others may then have the preferred configuration.

Also, a single lens support 30 may define multiple lenses 31, such as in segments or groups. For example, a plurality of lens supports 30 which each have one or more lenses 50 as detailed above, might be associated with the LEDs 20 (such as by connection to the printed circuit board 10 or housing of the light fixture). In such an embodiment, a single lens support 30 might define a plurality of light guides 40 and have a plurality of associated lens bodies 50 and the entire assembly might be located over different LEDs 20 or groups of LEDs.

In some configurations of the invention, the receiving portions 32 might be formed as individual elements or be formed as or comprise a matrix of elements and be associated with the LEDs 20 (such as placed on the printed circuit bord). The light guides 40 may also comprise individual elements or be formed or comprise a matrix of elements. In some embodiments, the receiving portions 32 and light guides 40 might comprise unitary elements that define a light guide from one or more LEDs 20 to at least one lens body 50.

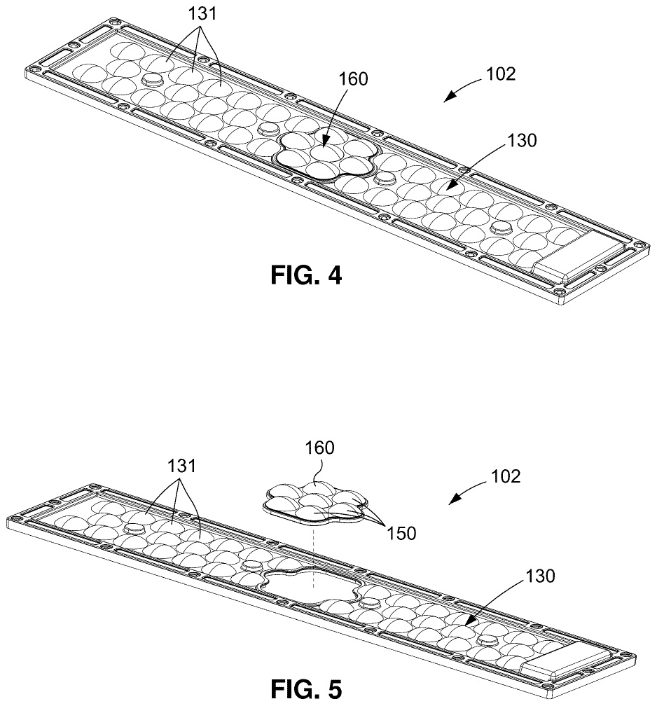

FIGS. 4 and 5 illustrate assembled isometric and exploded isometric views, respectively, of another light fixture 102, in accordance with another non-limiting embodiment of the disclosed concept. The light fixture 102 includes similar components as the light fixture 2 (FIGS. 1-3), wherein like elements are denoted with like reference numerals. As shown, the light fixture 102 has a plurality of individual lenses 131 which are defined by one or more common lens supports 130 (which may again be constructed from plastic or polymer materials) and one or more lens bodies 150 (which may again be constructed from glass).

In this configuration, no reflective member is utilized, although in other embodiments, reflective members may again be provided, such as in the manner described above.

Similar to the variation noted above, in this embodiment, the configuration of the lens bodies 150 may vary. For example, the amount or portion of each lens 131 which is defined by a glass lens body 150 may vary, such as depending upon the LEDs with which the lens 131 is associated, where the lens 131 is located, or based upon other factors. For example, in some cases the lens 131 might have a lens body 150 which comprises two or more portions or parts, where only one portion or part is glass (such as 50% or less or 50% or more) and the reminder comprises another material, such as plastic or other polymer, etc. Further, the location (such as orientation) of the lens body 150 may vary, such as based upon the direction of emitted light from the associated LEDs.

In some embodiments, areas or regions 160 (illustrated representatively in FIG. 5, it being understood that the region 160 is just illustrative) of the lens support 130 may have a particular configuration of lens bodies 150, such as having a first type or configuration of associated lens bodies (such as all glass, less than 50% glass, etc.), while other regions might have lenses 131 having a different configuration of lens bodies 150 (such as all polymer, etc.).

In one embodiment, the lens support 130 may be injection molded around glass or injection molded (or other formed) lens bodies 150, thus forming a unitary lens. The arrangement of the lens bodies 150, including location, size, shape, etc., may vary from lens to lens or in regions 160, such as depending upon factors such as the LEDs with which they are associated (including the range of light emitted thereby), the direction of light emitted by the LEDs, the location of the LEDs, etc.), to preferably reduce the effects of light degradation upon the lens support 130, while minimizing the cost or weight of the lens 131.

In this manner, advantages of the disclosed concept (e.g., cost effective way to emanate light while preserving different lenses against discoloration and structural degradation) are advantageously able to be realized with the light fixture 102, as well as the light fixture 2 (FIGS. 1-3). More specifically, while one or more of the lens bodies 150, or portions thereof, are preferably made of a glass material, the lens support 130 is preferably made of a lower cost plastic/polycarbonate, or other suitable material. This aspect of the invention may be applied to individual lens bodies, such as the lens bodies 50 illustrated in FIG. 2. However, as illustrated in FIG. 5, the multiple lens bodies 150 may be compart of a single structure or region 160 (such as comprising a glass structure defining the associated lens bodies 150 or glass and polymer defining different portions thereof). This lens body structure or region 160 might be associated with a lens support that defines multiple corresponding light guides.

It will be appreciated that while the lenses and lens structures described herein have been described with reference to example light fixtures, they may be used with light fixtures having other configurations. For example, the lens structures may be used with light fixtures which have other arrangements of LEDs, such as where the LEDs are associated with structures other than elongate planar printed circuit boards and associated housings, and even light fixtures having other types of illumination devices.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “example” as used herein indicates one among several examples, and it should be understood that no undue emphasis or preference is being directed to the particular example being described.

With regard to the methods described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

What is claimed is:

1. A light fixture comprising:
a printed circuit board;
a number of light emitting diodes (LEDs) electrically connected to the printed circuit board; and
at least one lens associated with one or more of the LEDs, the at least one lens comprising a lens support comprising a light guide, and a lens body associated with the light guide, wherein the lens support and the lens body are made of different materials.

2. The light fixture according to claim 1, wherein the light guide has a top end and a bottom end and a passage from said bottom end to said top end, said bottom end located adjacent to said printed circuit board.

3. The light fixture according to claim 1, wherein the lens body is located at said top end of said light guide.

4. The light fixture according to claim 1, wherein said lens support comprises a polymer material and the lens body comprises glass.

5. The light fixture according to claim 1, wherein the lens support further comprises a light guide support.

6. The light fixture according to claim 5, wherein the light guide support is configured to receive a bottom end of said light guide.

7. The light fixture according to claim 2, wherein said top end of said light guide defines an inset for receiving at least a portion of said lens body.

8. The light fixture according to claim 1, wherein said light guide defines an internal reflective wall from said bottom end to said top end.

9. The light fixture according to claim 8, wherein said wall is generally cylindrical in shape.

10. The light fixture according to claim 8, wherein said wall defines an interior light transmitting passage.

11. The light fixture according to claim 1, wherein said lens support defines a plurality of light guides.

12. The light fixture according to claim 1, wherein the light guide corresponds to a cluster of LEDs.

13. The light fixture according to claim 1, wherein the lens body comprises at least two materials, at least one of which differs from a material comprising said lens support.

14. A lens for a light fixture having one or more LEDs, comprising:
a lens support comprising a light guide; and
a lens body associated with the light guide, wherein the lens support and the lens body are made of different materials.

15. The lens according to claim 14, wherein said lens support comprises a polymer and said lens body comprises glass.

16. The lens according to claim 14, wherein said light guide has a first end and a second end and a cylindrical passage from said first end to said second end through which light emitted from said one or more LEDs is transmitted to said lens body.

17. The lens according to claim 16, wherein said passage is defined by a reflective wall.

18. The lens according to claim 16, wherein said second end has an inset receiving at least a portion of said lens body.

19. The lens according to claim 14, wherein said lens body defines a plurality of light guides.

20. The lens according to claim 19, wherein a lens body is associated with each of said plurality of light guides.
